(19) United States
(12) Patent Application Publication
(10) Pub. No.: US 2008/0116377 A1
(43) Pub. Date: May 22, 2008

(54) Method and System for Passive Remote Exhaust Emission Measurement

(76) Inventor: Wai Ming Luk, Kowloon (HK)

Correspondence Address: RABIN & Berdo, PC, 1101 14TH STREET, NW, SUITE 500, WASHINGTON, DC, 20005, US

(21) Appl. No.: 11/941,328

(22) Filed: Nov. 16, 2007

Related U.S. Application Data
(60) Provisional application No. 60/859,513, filed on Nov. 17, 2006.

(51) Int. Cl. G01N 21/35

(52) U.S. Cl. 250/338.5

(57) ABSTRACT

The present invention relates to methods and systems for passive remote exhaust emissions measuring, comprising: an infra-red radiation detection sensor array, a lens and a processing unit; wherein the infra-red radiation detection sensor array detects IR radiations in multiple IR regions for a common physical area and generates multiple IR images concurrently at any one time instance, and the processing unit detects and identifies the presence of hotspots of radiation of the IR images by which the concentrations, relative ratio and absolute emission values of various gas components can be calculated.

### CROSS-REFERENCE TO RELATED APPLICATIONS

The present invention claims priority to U.S. Provisional Patent Application Ser. No. 60/859,513 as filed in 17 Nov. 2006, which is in whole incorporated herein by reference.

### FIELD OF THE INVENTION

The present invention relates to remote exhaust emissions analysis, more particularly to methods and systems for passive remote exhaust emissions measuring.

### BACKGROUND OF THE INVENTION

Existing remote gas analyzers require an artificial radiation source set on one side of a traffic lane to emit a light beam through an emission plume of a vehicle to impinge on a reflecting device set on the other side of a traffic lane, and the beam is subsequently reflected to and received by a gas analyzer on the emitter side that analyzes the intensity of the radiation and generates a gas reading or readings based on the amount of radiation in the light beam absorbed by the emission plume. Such remote sensing systems are disclosed in U.S. Pat. No. 5,726,450, in which a collimated beam is emitted from a radiation source and set to pass through the exhaust plume of a vehicle; the light beam is subsequently reflected from an adjustable mirror to the focusing mirrors thereof and in turn directed at a plurality of detectors through the respective filters sequentially. Another invention disclosed in U.S. Pat. No. 5,498,872 utilizes a light source on one side of the traffic lane emitting a light beam through an emission plume of a vehicle and into a receiver set on the other side of the traffic lane.

The common drawback of all of these set-ups of remote gas measurement systems is they all require equipments to be placed on both sides of the traffic lane being monitored, and involve multiple equipment modules including emitter, receiver, reflective mirror, speed detection units, video capture unit, processing unit, and interconnecting hubs and cables, which volume of setup leads to bulkiness, lengthy setup time and reduced efficiency of application. Also, these systems require alignment of radiation emitter and the reflecting mirror or receiver on the other side of the road. In most road situations, monitoring of single traffic lane using remote sensing technology is tedious, and monitoring of multiple traffic lanes is impossible due to bulky equipment set-up and excessive interference to the traffic flow.

Existing technology provides for the capturing of IR images over an area, such that the IR data of the actual area being captured is represented by a grid of image pixels, each of different value, that denote the radiation intensity of each corresponding location it captures. Such IR imaging technology can form the basis for remote sensing analysis of gas concentration, in which the radiation intensity of each pixel area of the image can be recorded when the device is set to detect a specific radiation wavelength. However, existing IR image capturing technology can only detect one radiation channel over a wide spectral range at one time instance, therefore incapable of analyzing multiple gases simultaneously.

Existing IR imaging technology also lacks image analysis functions specifically for defining groups of pixels as valid emission plumes exhausted from vehicles, nor does it possess the function for differentiating multiple emission targets within the capture area and recording them accordingly in separate data records.

### SUMMARY OF THE INVENTION

In light of the drawbacks in existing remote sensing emission measurement technologies, it is an object of the present invention to provide an effective remote vehicle emissions measurement system that only requires a single view perspective toward the traffic lane monitored, and which can thus be installed on only one side of the traffic lane, to analyze multiple gas components for multiple vehicles on multiple traffic lanes, in a concurrent and instantaneous manner.

It is another object of the present invention to produce remote sensing gas measurement data in a single equipment module, hence greatly reducing the complexity and bulkiness of remote sensing operations.

Another object of the present invention is to capture and utilize IR images of the measurement target for purpose of computing exhaust gas emission in carbon monoxide (CO), carbon dioxide (CO2), hydrocarbons (HC), nitric oxides (NOX), and other gaseous and particulate emission, such as sulfuric oxides (SOX) and particulate matter (PM), from in-use vehicles.

It is another object of the present invention to provide a means of remote gas detection and measurement without the need to actively emit an artificial light beam, by utilizing the radiation emitted from the exhaust gas as the basis on which gas measurements are computed and analyzed.

It is yet another object of the present invention to extend the amount of time available for gas measurement by taking gas measurements from the rear instead of from the side of the target vehicle.

Still another object of the present invention is to provide an IR hotspot identification mechanism to detect the entrance of a vehicle into the capture area, and to further differentiate emissions from multiple vehicles, and process multiple records separately, therefore allowing multiple vehicles on multiple traffic lanes to be monitored simultaneously.

It is a further object of the present invention to collect a sequence of emission data of various gas components for each measurement target within the time period where the measurement target is within the sight range of the measurement device, so that the sequence of emission data taken can be processed to generate conclusions on the measurement target's mode of operations. In one example, multiple IR images taken for a vehicle can be analyzed to determine whether the vehicle exhaust system is in transient mode, i.e. switching between a high air-fuel ratio and a low air-fuel ratio, by comparing a sequence of emission images and analyzing the switches in CO and NO content, which signifies transient state engine operation.

The above objects and advantages of the present invention can be achieved by providing a remote IR imaging device that can simultaneously capture multiple IR images, where each image serves to capture radiation in a wavelength band that correspond to a gaseous or particulate pollutant of concern, whereby each of the images will cover the same image extent at the exact same time instance, forming a collection of emission images for CO, CO2, HC, NOX, and/or other gaseous or particulate pollutants. The device comprises a central IR sensor unit composed of one group of sensors (a “sensor group”) for each image pixel in the output image, and each sensor group is composed of a plurality of sensors set to detect and measure radiation intensity in different wavelength bands. The device includes a hotspot identification mechanism, using a system of adjustable group definition, to detect the appearance of vehicles in the capture area by identifying IR concentration from the high-temperature emission plumes of vehicles, thereby differentiating emission from different vehicles and analyze them as separate records. As such, the system is capable of separating multiple hotspots within the image extent and storing them in separate case records for processing. The device also comprises multi-image (time-sequence) processing capability and 3D modelling capability to detect the direction and movement of each hotspot, thereby computing the speed and acceleration of the target vehicle. The gas values for the same vehicle emissions over a time-series are utilized to analyze the mode of operation of the vehicle target (e.g. engine transient). The device provides the option for installing additional sensors into the sensor arrangement to include automatic license plate recognition capability. A processing unit set either within the central module as an internal processing unit or in the form of a computer receives the image data from the sensor array as a collection of pixel values, performs hotspot identification to define a target and separate multiple targets, stores and analyzes each record as an entry in a database, performs multi-image processing to detect speed, acceleration, mode of operation, etc., averages the emission measurements over multiple time instances, and records an emission reading in percentage or concentration for each vehicle. The passive remote vehicle emissions measurement system can be operated handheld or be mounted and set up temporarily or permanently at roadside for measuring the exhaust emissions directly from a vehicle passing by.

### BRIEF DESCRIPTION OF THE DRAWINGS

FIG. 1 is a diagram of the passive remote emission sensing device 1 comprising IR sensor unit 2, lens 3, and processing unit 4.

FIG. 2 illustrates the sensor array 5 in the invention, wherein individual sensors 6 are set variously to detect and analyze different vehicle exhaust gases, forming sensor groups 7, with each sensor group 7 analyzing one pixel in the output image.

### DETAILED DESCRIPTION OF THE INVENTION

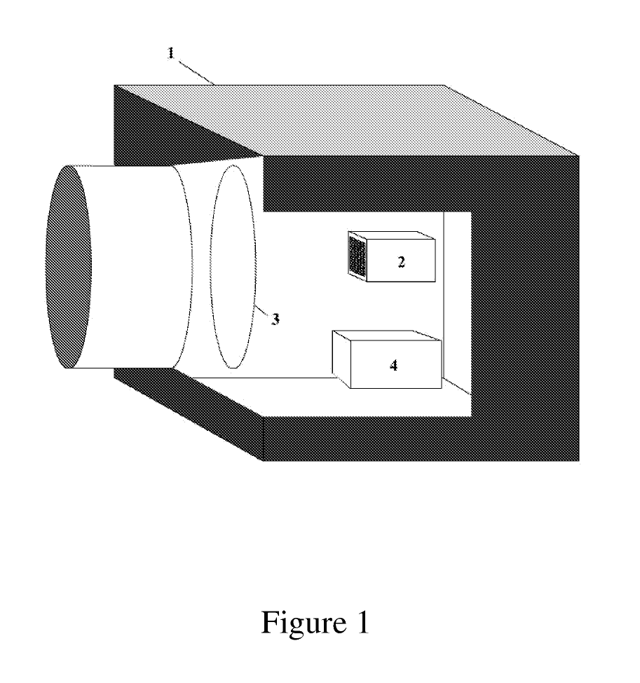

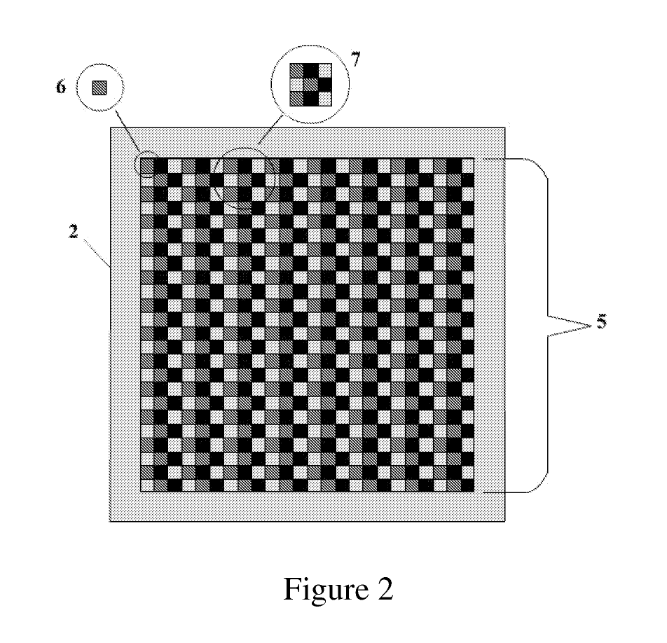

The present invention provides a remote vehicle emissions measurement system comprising a central module 1 (FIG. 1). The central module is composed of an IR sensor unit 2, a lens 3 used to focus radiation onto the IR sensor unit, and a processing unit 4. The IR sensor unit 2 is formed by an IR sensor array 5 (FIG. 2), wherein IR sensor groups 7 are aligned in columns and rows. Each sensor group 7 is set to detect one pixel area of the actual location, and each sensor group 7 is composed of a plurality of IR sensors 6. There is no fixed limit for the maximum number of individual sensors 6 in each sensor group 7. Each sensor 6 in the sensor group 7 is set to detect one type of gaseous or particulate pollutant, including CO, CO2, HC, NOX, SOX, PM, plus one or more sensors inside the group being set as the reference channel(s). The reference channel is set to measure temperature and other IR radiation of the target pixel area. As each sensor group 7 will analyze the same actual area of the target location, the combination of the entire sensor array produces as many IR images as the number of gaseous the device is set to analyze.

The total number (N) of individual sensors 6 and of sensor groups 7 in the IR sensor array 5 is determined by

N of Sensor Groups 7 in IR Sensor Unit 2=Image Resolution (e.g. 2304 pixels×1728 pixels)

N of Individual Sensors 6 in IR Sensor Unit 2=N of Sensor Groups 7 in IR Sensor Unit 2*N of Channels

N of Channels=Number of gaseous or particulate pollutant to be monitored by device+Number of reference channels utilized

The IR sensor unit 2 is situated behind a lens 3 such that radiation from the measurement target area will be directed to focus on the IR sensor unit 2.

For every time instance that a vehicle's emission plume is present in the image area, the processing unit 4 detects the presence of vehicle emission by a hotspot identification mechanism. The processing unit 4 receives the data collected by all sensors, and composes multiple IR images based on the sensors' assigned pixel locations and channels monitored. As such, one IR image is composed for each gas at each time instance. For example, data from all sensors set to measure CO at t₀ are collected by the processing unit, which puts the pixel readings from the sensor into columns (C) and rows (R) according to the sensor's assigned pixel location as follows
C1 R1, C2 R1, C3 R1, . . . Cn R1
C1 R2, C2 R2, C3 R2, . . . Cn R2
. . .
. . .
C1 Rn, C2 Rn, C3 Rn, . . . Cn Rn

As such, the processing unit collects data for all remaining gases (CO2, HC, NOX, etc.) and reference channels, and create as many IR images as the number of sensors in each sensor group 7.

The detection of additional gases and particles of emission—such as SOx and PM—can be accomplished by expanding every sensor group to contain additional sensors for corresponding pollutants. The system in this setup can capture a whole image of the measurement target and discriminate a multitude of wavelength bands in the measurement target.

Additional IR sensors can optionally be incorporated in each sensor group, such that the invention can compile an additional IR image at each time instance to perform automatic license plate recognition (ALPR). The sensors installed for ALPR will be of suitable IR wavelength channel for the application. The processing unit will also incorporate software for processing ALPR using the collected data and established ALPR techniques.

The hotspot identification mechanism is performed by detection of adjoined groups of pixel with pixel value and total number of adjoined pixels matching the criteria set for group definition. The criteria for group definition is

Hotspot=Valid Group=P(ZX_{Y})

where
Y=Preset Intensity for a Predefined Radiation Wavelength Region corresponding to a Gaseous Chemical, in Percentage or Concentration
XY=Recorded Radiation Intensity in a Pixel exceeding Preset Intensity Y
ZX_{Y}=Number of Adjoined Pixels with Recorded Radiation Intensity XY
P=Preset Minimum No. of Pixels for Group Definition

As such, the user sets the minimum value of intensity for definition as vehicle emission, and minimum number of pixels to be defined as a valid hotspot. Group definition can be performed using the temperature reference channel, because vehicle emission is generally at temperature well over 100 degree Celsius. Low temperature exhaust can be excluded from measurement because it is likely from a cold-start vehicle, i.e. a vehicle started shortly before measurement is taken, and cold-start vehicles cannot accurately be measured for emission. The processing unit 4 takes the collection of IR images for each time instance where at least one hotspot is present in the image area.

A new case record is created each time a new hotspot is detected inside the image, representing one vehicle emission record. The same hotspot is tracked in multiple consecutive images to record a gas reading for each gas at each time instance. All consecutive gas readings for the same vehicle collected between first to last appearance of hotspot is stored in the database for processing.

A number of scenarios will govern how final emission reading will be processed and determined. For vehicles not equipped with close-loop control device, the gas measurement of each instance should be compatible and the emission result of the vehicle will be determined by averaging all consecutive readings. Vehicles equipped with close-loop control systems will display engine transient during operation, which is signified by cyclical high- and low-points of emission in roughly 0.8-second cycles. In this case, the processing unit in the remote sensing device will detect the presence of engine transient by its pattern. By plotting the increases and decreases in emission, the processing unit filters out the outliners of emission peaks and gorges from the data, and apply the averaging method to compute final emission result. The equation for averaging multiple emission measurement is well-known in the art, and is therefore omitted.

The computation of vehicle speed and acceleration is performed by a comparison of multiple IR images using a 3D mapping technique, wherein a center point is identified for each hotspot using a stable channel such as the temperature or reference channel, and utilizing a selectable averaging technique. The averaging options could include a number of common mathematical averaging methods or kernel algorithms that are selectable by the user based on preference. When the center point of hotspot is tracked over consecutive images, the processing unit maps the direction and distance traveled by the hotspot using four, or preferably as many as possible, user-input reference points that defines the 3D plain in the image.

When automatic license plate recognition capability is incorporated in the device, the processing unit will search for the license plate of the vehicle within a preset distance from the center of the hotspot, as the emission plume should be within a reasonable distance from the rear license plate. The processing unit then matches the license plate read with the emission data collected, and store them in the database accordingly. The error of matching a license plate to an adjacent vehicle is insignificant, as the distance from a vehicle's exhaust pipe to its own license plate should in most cases be shorter than its distance to that of an adjacent vehicle. A further mechanism to ensure a correct match of license plate to its hotspot is by monitoring the distance between the center point of hotspot and a point on the license plate (e.g. lower left or lower right) over multiple images, as this distance should be highly constant, and outliners can be invalidated as incorrect matches.

Preferably, the foregoing system further comprises an embedded wireless communication unit that employs a wireless network communication such as WiFi, WiMAX, Bluetooth or the like, for allowing the system to send data to a computer wirelessly, thus serving as a telemeter that transmits measurement data to a controlling device disposed at a distance.

Preferably, the foregoing system further comprises an additional color camera within the central module for taking a color overview image of the measurement target.

Preferably, the foregoing system further comprises a panel of switches, buttons, and/or similar controlling devices for controlling the central module.

Preferably, the foregoing system further comprises a color or monotone display screen on the surface of the central module to display the functions and status of operations.

Preferably, the foregoing system further comprises a touch-screen display for controlling the central module and to display the functions and status of operations.

Preferably, the foregoing system further comprises built-in memory and external, expandable memory port for data storage.

Preferably, the foregoing system further comprises a battery.

What is claimed is:

1. A passive remote emissions measurement system for simultaneously capturing multiple IR images of emission gases, comprising:
an Infra-red (IR) radiation detection sensor array for detecting and receiving a plurality of IR images in predetermined wavelength bands emitted from the emission plume of vehicles;
a lens for focusing radiation from emission target onto IR radiation sensor array;
a processing unit interconnecting with the IR radiation detection array for analyzing and processing the data collected by the detection array; characterized in that
the IR radiation detection sensor array comprises combinations of multiple sensors so arranged to simultaneously detect IR radiations in multiple IR regions for a common physical area, allowing for the generation of multiple IR images of multiple IR wavelength bands concurrently at any one time instance;
the processing unit comprises one or more specific software and hardware for
(a) detecting the presence of hotspots of radiation and identifying the hotspots as vehicle emission;
(b) analyzing multiple consecutive IR images captured for calculating the concentrations of various gas components in vehicle emission, the relative ratio of one gas components to the others, or the absolute emission values of each of the gas components.

2. The system as claimed in claim 1, wherein it further comprises an embedded power supply unit.

3. The system as claimed in claim 2, wherein the embedded power supply unit comprises a storage battery.

4. The system as claimed in claim 1, wherein it further comprises an embedded wireless communication unit.

5. The system as claimed in claim 4, wherein the embedded wireless communication unit comprises WiFi, WiMax, bluetooth, GPRS, UMTS, FOMA, WCDMA, CDMA-2000, TD-SCDMA, or HSDPA.

6. The system as claimed in claim 1, wherein it further comprises an image capture unit being interconnected with the processing unit for capturing or recording a color overview image of the target(s).

7. The system as claimed in claim 1, wherein it further comprises optical character recognition sensors to perform automatic character recognition such as automatic license plate recognition functions.

8. The system as claimed in claim 1, wherein it further comprises a panel of switches, buttons, or similar controlling devices for controlling the central module.

9. The system as claimed in claim 1, wherein it further comprises a color or monotone display screen on the surface of the central module to display the functions and status of operations.

10. The system as claimed in claim 9, wherein the display screen comprises a touch-screen control for controlling the central module and to display the functions and status of operations.

11. The system as claimed in claim 1, wherein it further comprises built-in memory

12. The system as claimed in claim 1, wherein it further comprises external memory port for data storage.

13. A method of remote sensing the emissions of a vehicle by passively taking emission information from the target without the need for actively emitting and receiving radiation, comprising the steps of:
simultaneously gathering multiple IR imageries in order to analyze the various spectral properties of the emission target(s) in CO, CO2, HC, NOx, PM, SOx;
differentiating multiple targets by identifying high-intensity emission “hotspots” on the emission image;
gathering a predetermined number of consecutive IR imageries to detect speed and acceleration data of target(s);
checking whether there is any transient change between CO and NOX to determine if the target vehicle(s) is(are) in engine transient mode; and
calculating and presenting the concentrations of various gas components thereof, the relative ratio of one gas component to the others, or the absolute emission values of each of the gas components thereof.
